(19) United States
(12) Patent Application Publication
(10) Pub. No.: US 2018/0233761 A1
(43) Pub. Date: Aug. 16, 2018

(54) SELF-CHARGING IMPLANTABLE POWER SOURCE WITH BIOSENSOR FUNCTIONALITY

(71) Applicant: Gymama Slaughter, Finksburg, MD (US)

(72) Inventor: Gymama Slaughter, Finksburg, MD (US)

(21) Appl. No.: 15/801,091

(22) Filed: Nov. 1, 2017

Related U.S. Application Data
(60) Provisional application No. 62/415,760, filed on Nov. 1, 2016.

(51) Int. Cl. H01M 8/16; H02J 7/00

(52) U.S. Cl. CPC H01M 8/16; H02J 7/345; H02J 7/0068

(57) ABSTRACT

An analyte-based self-charging implantable power source that can also exhibit biosensor functionality is provided that utilizes a biofuel cell in combination with amplifying circuitry. The power source utilizes a biofuel cell and supplies relatively high power at useful voltages by converting the chemical energy stored in an analyte, such as glucose, which is a renewable energy source within the body, utilizes safe bio-based materials that pose no harm to the human body, and has the added benefit of being capable of sensing the levels of the analyte used for the biofuel cell (for example, blood glucose levels if blood glucose is used as the biofuel) at the same time, while retaining the volumetric energy density of the system.

This application claims priority to U.S. Provisional Application Ser. No. 62/415,760 filed Nov. 1, 2016, whose entire disclosure is incorporated herein by reference.

### GOVERNMENT RIGHTS

This invention was made with government support under Award No. 1349603 awarded by the National Science Foundation (NSF). The government has certain rights in this invention.

### BACKGROUND OF THE INVENTION

### 1. Field of the Invention

The present invention relates to compact power sources and, more specifically, to compact power sources that are analyte-based and that can also function as a bio sensor.

### 2. Background of the Related Art

The global lithium ion battery market is expected to reach $46.21 billion by 2022. A boom in implantable and wearable devices is driving battery manufacturers to invest heavily in the production of batteries that are safe, lightweight, flexible, thin, and conformal.

As implantable electronic devices become smaller and smaller, our battery technology remains relatively the same. That is, bulky, rigid and toxic, thereby posing a challenge for the integration with microsized implantable devices. Lithium-ion battery is reaching its limits in terms of miniaturization. Further, batteries for implantable medical devices are potentially toxic and cannot meet form factor needs for microdevices. In addition, replacement of battery-operated implantable medical devices is surgically disruptive, requires anesthesia, and costs approximately $20,000-$96,000 or more per procedure depending on the type of device and the length of hospitalization.

### SUMMARY OF THE INVENTION

An object of the invention is to solve at least the above problems and/or disadvantages and to provide at least the advantages described hereinafter.

Therefore, an object of the present invention is to provide an analyte-based power system for powering devices.

Another object of the present invention is to provide an analyte-based power system for powering devices that can also be used to measure the concentration of an analyte.

Another object of the present invention is to provide an implantable analyte-based power system for powering implantable devices.

Another object of the present invention is to provide an analyte-based power system for powering wearable devices.

Another object of the present invention is to provide a glucose-based power system for powering devices.

Another object of the present invention is to provide a power system for powering devices that utilizes a glucose biofuel cell.

Another object of the present invention is to provide a power system for powering devices that utilizes a lactate biofuel cell.

Another object of the present invention is to provide a glucose biofuel cell system that can be used to power devices and measure concentrations of glucose at the glucose biofuel cell.

Another object of the present invention is to provide a lactate biofuel cell system that can be used to power devices and measure concentrations of lactic acid at the glucose biofuel cell.

Another object of the present invention is to provide an implantable device that is powered by a glucose biofuel cell system.

Another object of the present invention is to provide an implantable device that is powered by a lactate biofuel cell system.

Another object of the present invention is to provide a wearable device that is powered by a glucose biofuel cell system.

Another object of the present invention is to provide a wearable device that is powered by a lactate biofuel cell system.

Another object of the present invention is to provide a glucose-based power system for powering devices that utilizes a glucose biofuel cell, a voltage amplifier and a capacitor.

Another object of the present invention is to provide a lactate-based power system for powering devices that utilizes a glucose biofuel cell, a voltage amplifier and a capacitor.

Another object of the present invention is to provide a glucose-based power system for powering devices that utilizes a glucose biofuel cell, a charge pump integrated circuit and a capacitor.

Another object of the present invention is to provide a lactate-based power system for powering devices that utilizes a glucose biofuel cell, a charge pump integrated circuit and a capacitor.

Another object of the present invention is to provide a glucose-based power system for powering devices that utilizes a glucose biofuel cell, a charge pump integrated circuit, a capacitor and a step up DC converter.

Another object of the present invention is to provide a lactate-based power system for powering devices that utilizes a glucose biofuel cell, a charge pump integrated circuit, a capacitor and a step up DC converter.

Another object of the present invention is to provide a glucose-based power system for powering devices that utilizes a glucose biofuel cell, a voltage amplifier and a capacitor, that also determines a concentration of glucose at the glucose biofuel cell based on a charge/discharge frequency of the capacitor.

Another object of the present invention is to provide a lactate-based power system for powering devices that utilizes a glucose biofuel cell, a voltage amplifier and a capacitor, that also determines a concentration of lactic acid at the lactate biofuel cell based on a charge/discharge frequency of the capacitor.

To achieve at least the above objects, in whole or in part, there is provided an analyte-based power system, comprising a biofuel cell, wherein the biofuel cell is adapted to generate an electric signal in the presence of a predetermined analyte, a voltage amplifier in electrical communication with the biofuel cell that is adapted to receive the electric signal, amplify the voltage of the electric signal, and output a voltage-amplified electric signal, and a capacitor in electrical communication with the voltage amplifier such that the voltage amplified electric signal charges the capacitor, wherein the voltage amplifier is adapted to: (1) charge the capacitor with the voltage amplified signal; (2) discharge the capacitor when the capacitor voltage reaches a predetermined level (“discharge voltage”); and (3) re-charge the capacitor with the voltage amplified signal after the capacitor has discharged.

To achieve at least the above objects, in whole or in part, there is also provided an analyte-based power system, comprising a biofuel cell, wherein the biofuel cell is adapted to generate an electric signal in the presence of a predetermined analyte, a voltage amplifier in electrical communication with the biofuel cell that is adapted to receive the electric signal, amplify the voltage of the electric signal, and output a voltage-amplified electric signal, and a capacitor in electrical communication with the voltage amplifier such that the voltage amplified electric signal charges the capacitor, wherein the voltage amplifier is adapted to: (1) charge the capacitor with the voltage amplified signal; (2) discharge the capacitor when the capacitor voltage reaches a predetermined level (“discharge voltage”); and (3) re-charge the capacitor with the voltage amplified signal after the capacitor has discharged, an amplification circuit in electrical communication with the capacitor such that the amplification circuit receives electrical signals discharged from the capacitor (“discharge signals”), wherein the amplification circuit amplifies the discharge signals and outputs amplified discharge signals, and a device in electrical communication with the amplification circuit such that the device receives the amplified discharge signals, wherein the device is adapted to be powered by the amplified discharge signals.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1A is a block diagram of a glucose-based biofuel power and sensing system, in accordance with one preferred embodiment of the present invention;

FIG. 1B is a block diagram of a glucose-based biofuel power and sensing system, in accordance with another preferred embodiment of the present invention;

FIGS. 2A and 2B are schematic diagrams illustrating one preferred embodiment of a glucose biofuel cell construction using a dense mesh network of multi-walled carbon nanotubes;

FIG. 3A is a graph showing the typical electrocatalytic response of the bioanode in the absence (a) and presence (b) of 5 mM glucose;

FIG. 3B is a graph showing the typical electrocatalytic response of the biocathode in the absence (a) and presence (b) of oxygen saturated PBS;

FIG. 4A is a graph showing polarization characteristics of the glucose biofuel cell composed of the PQQ-GDH modified buckypaper bioanode and the BOD modified buckypaper biocathode operating in increasing standard glucose solution (37° C., pH 7.4 [3, 5, 7, 10, 15, 20 mM]);

FIG. 4B is a graph showing the power curve as the function of the current density for the glucose biofuel cell;

FIG. 4C is a graph showing the calibration curve of the glucose biofuel cell (peak power density vs. glucose concentration levels);

FIG. 5 is a schematic diagram of the charge pump IC, in accordance with one preferred embodiment of the present invention;

FIG. 6 are graphs showing the effect of glucose concentration levels on the charging/discharging frequency of the capacitor connected to the charge pump IC operating in the presence of 3 mM, 5 mM and 10 mM glucose;

FIG. 7A is a graph showing the effect of pH on the response of the glucose biofuel cell at 37° C. in 7 mM glucose;

FIG. 7B is a graph showing the response curve of the glucose biofuel cell to 7 mM glucose under various temperatures at 37° C., pH 7.4;

FIG. 8A is a schematic circuit diagram of the charge pump IC interfaced to the step-up DC convertor and its application in powering a glucometer within 300 ms while sensing glucose via the charging/discharging frequency of the capacitor, in accordance with one embodiment of the present invention;

FIG. 8B is a graph showing the dependence of the charging/discharging frequency of the capacitor on glucose concentration, as measured with the glucose-based biofuel power system of the present invention;

FIG. 8C is a graph showing the operational stability response of the glucose-based biofuel power system of the present invention in various glucose concentrations (3, 5, 7, 10, 15, 20 mM);

FIG. 9 is a schematic diagram of a lactate-based biofuel power and sensing system, in accordance with one embodiment of the present invention;

FIG. 10 is a graph showing cyclic voltammograms: (a) in absence of lactic acid; (b) in the presence of 7 mM lactic acid; and (c) in the presence of 15 mM lactic acid;

FIG. 11 is a graph showing cyclic voltammograms: (a) in air; and (b) in oxygen saturated environment;

FIG. 12 is a graph showing polarization curves of lactate biofuel cells including D-LDH/MWCNTs as anodic catalyst and BOD/MWCNTs as cathodic catalyst, using 1 mM-25 mM lactate solution as a fuel;

FIG. 13 is a graph showing 14-day measurements of electrical power generation activity of a lactate biofuel cell (peak power measured with a 200 kΩ load);

FIG. 14 is a block diagram of a lactate-based biofuel power and sensing system, in accordance with one embodiment of the present invention; and

FIG. 15 is a graph showing a calibration curve of a lactate-based biofuel power and sensing system, in accordance with one embodiment of the present invention.

### DETAILED DESCRIPTION OF PREFERRED EMBODIMENTS

The present invention provides an analyte-based biofuel power and sensing system that is an alternative to a traditional battery. It is smaller than traditional batteries and bio-safe, and thus can be utilized in miniaturized implantable devices, such as pacemakers, implantable cardioverter defibrillators (ICDs), artificial hip and knee infection detectors, cochlear hearing implants, artificial eye lenses integrated with sensors, PillCam capsule endoscopy, and others. As used herein, the term “implantable devices” refer to any device that is designed to be implanted into a living organism. The present invention can also be used to power wearable devices, such as smart watches, wristbands, smart glasses, epidermal sensors, wearable biosensors (glucose, lactate and nitric oxide patches), hydration, temperature, pressure and strain sensors, accelerometers, gyroscopes, and others.

The present invention is a self-powered technology that: 1) supplies high power at useful voltages by converting the chemical energy stored in an analyte, such as glucose, which is a renewable energy source within the body; 2) utilizes safe bio-based materials that pose no harm to the human body; and (3) has the added benefit of sensing the levels of the analyte used for the biofuel (for example, blood glucose levels if glucose is used as the biofuel) at the same time, while retaining the volumetric energy density of the system. These features enable the analyte-based biofuel power and sensing system of the present invention to operate without requiring batteries, thereby enabling simultaneous generation of power for miniaturized implantable devices and monitoring of blood metabolites (e.g., blood glucose) to improve patient health outcomes.

One application that could benefit from a compact, implantable power source is glucose monitoring in individuals with diabetes. Diabetes is a metabolic disorder caused by the inability of pancreatic β-cells to produce sufficient amount of insulin needed for blood glucose control, thereby leading to high blood glucose levels. According to the 2012 CDC report, 29.1 million people in US suffer from diabetes while 86 million people suffer from pre-diabetes.

Current continuous glucose monitor (CGM) technologies require the patient to insert a tiny sensor under the skin that measures blood glucose levels. The sensor remains under the skin for several days to a week before it is replaced with a new sensor. This approach to monitoring blood glucose level is very helpful to patients who suffer from haemophobia. However, CGM uses a potentiostatic circuit to acquire blood glucose information, which requires the use of an external power source, such as a battery. Moreover, CGM devices are not as accurate as the standard blood glucose meters and one has to confirm the blood glucose level with glucose meters before making any changes in their treatment regimen.

Researchers have been seeking to bridge the gap between glucose monitoring and insulin delivery by developing artificial pancreas, which would consist of a CGM system, an insulin delivery system and a computer program that adjusts the insulin delivery based on changes in the blood glucose levels. Though the bridge between the glucose monitoring and insulin delivery systems have been implemented in the early stages, a self-powered glucose biosensor utilizing the power source of the present invention has the potential to overcome the shortcomings of glucose monitors based on potentiostatic circuits by autonomously monitoring blood glucose continuously.

Accordingly, the analyte-based biofuel power and sensing system of the present invention will be primarily described and illustrated in conjunction with the use of glucose as the biofuel analyte. However, it should be appreciated that the present invention can be implemented with other types of analytes used as biofuel, such as lactate, as will be described in more detail below.

An embodiment of the present invention combines the operating principles of a glucose biofuel cell and a glucose biosensor. The glucose biofuel cell consists of an anode, a cathode and an electrolyte containing glucose fuel. The oxidation of glucose at the anode results in power generation, which can be utilized to power bioelectronics devices, as well as to provide glucose concentration information. Hence, it eliminates the need for external power sources and utilizes the glucose fuel in the body to simultaneously generate bioelectricity and monitor blood glucose levels.

The power produced by a single biofuel cell is, however, not sufficient to power an implantable bioelectronics device (e.g., a glucose biosensor). Although stacked multiple glucose biofuel cells may fulfill the power requirement needed to power a glucose biosensor, it results in an overall bulky device, thereby defeating the purpose of a miniaturized implantable biofuel cell device.

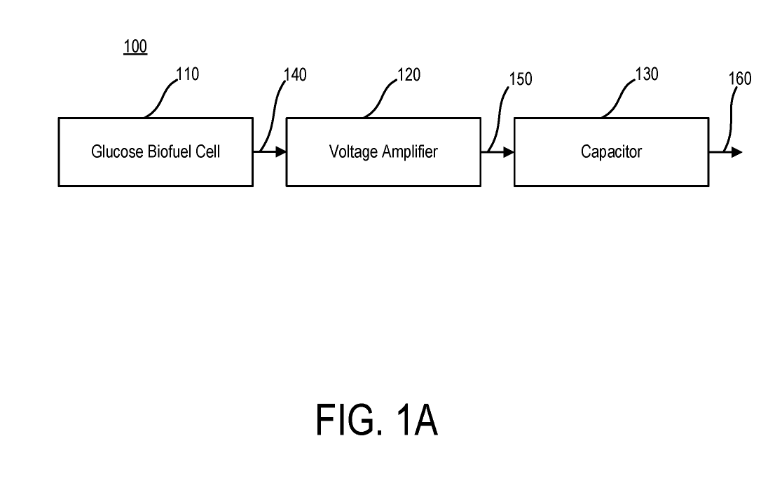

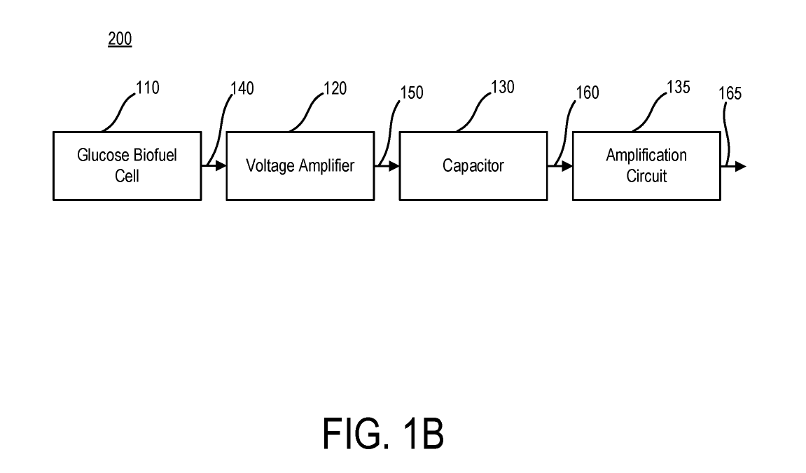

FIG. 1A is a block diagram of a glucose-based biofuel power and sensing system 100 that overcomes these limitations, in accordance with one embodiment of the present invention. The system 100 includes a glucose biofuel cell 110, a voltage amplifier 120 and a capacitor 130. The combination of a voltage amplifier 120 and capacitor 130 with glucose biofuel cell 110 results in a system 100, as small as 3 mm×4 mm or smaller, that can simultaneously power bioelectronics and sense the analyte being used for the biofuel cell 100 (e.g., glucose). Although a glucose biofuel cell 110 is shown and will be described, it should be appreciated that an enzymatic-based biofuel cell that uses other types of analytes can be used while still falling within the scope of the present invention.

In a preferred embodiment, the voltage amplifier 120 is a charge pump integrated circuit (IC) and thus the voltage amplifier 120 will hereinafter be referred to as a charge pump IC. However, it should be appreciated that any other types of voltage amplifiers may be used.

In operation, the glucose biofuel cell 110 generates an electrical signal 140 in the presence of glucose. The combination of the charge pump IC 120 and capacitor 130 function as an amplification circuit. Specifically, the electrical signal 140 from the glucose biofuel cell 110 serves as the input signal to the charge pump IC 120. The charge pump IC amplifies the voltage of the electrical signal 140 and outputs the amplified electrical signal 150 to the capacitor 130. Once the capacitor is fully charged, the charge pump IC 120 discharges the capacitor 130. The output 160 of the capacitor 130 can be used as a power source for other devices. Further, the charging/discharging frequency of the capacitor 130 can be used to determine glucose analyte concentration, as will be explained in more detail below.

FIG. 1B is a block diagram of a glucose-based biofuel power and sensing system 200, in accordance with another embodiment of the present invention. The system 200 is similar to the system 100 described above, except that an amplification circuit 135 is used to further amplify the electrical signal from the capacitor 130. The amplification circuit 135 is preferably a step-up DC electrical power converter that receives the electrical signal 160 from capacitor 130 and outputs a steady state electrical signal 165 at a higher voltage and higher current than the signal 160 from the capacitor 130.

### The Glucose Biofuel Cell

Strips of buckypaper are preferably used as the electrode material in the glucose biofuel cell 110 because of the high surface area for enzyme loading afforded by the mesh network of carbon nanotubes. Buckypaper is composed of a compressed network of multi-walled carbon nanotubes CNTs).

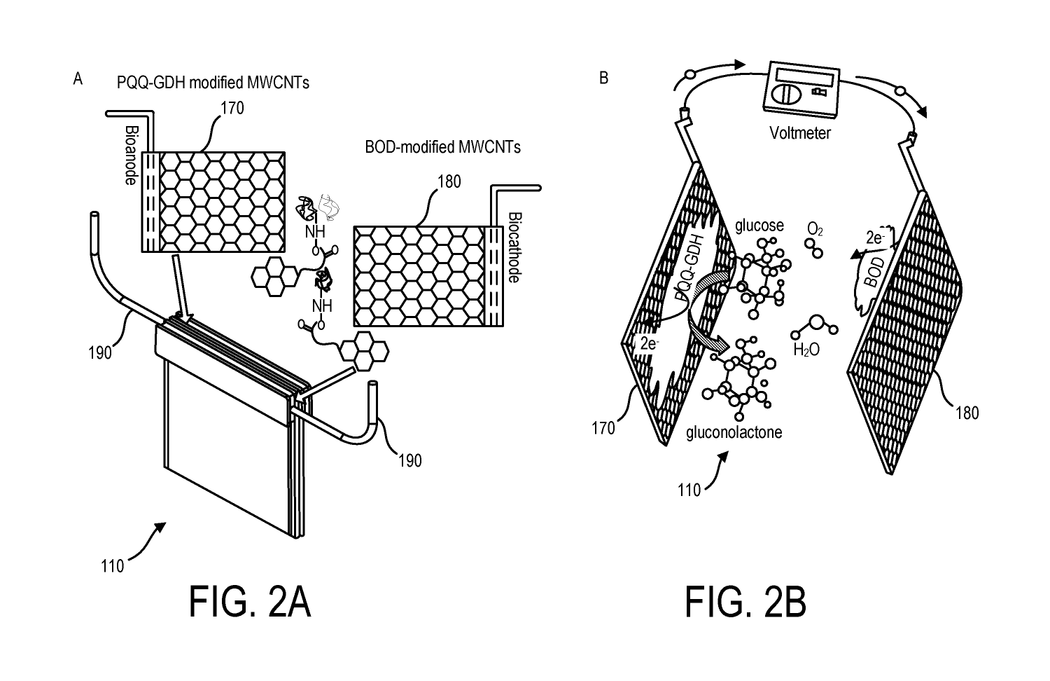

FIGS. 2A and 2B are schematic diagrams illustrating one preferred embodiment of a glucose biofuel cell 110 construction using a dense mesh network of MWCNTs. To functionalize the surface of the bioelectrodes, a multi-step approach is preferably used. Each bioelectrode surface is first treated with a heterobifunctional crosslinker, 1-pyrenebutanoic succinimidyl ester (PBSE, 1 mM) prepared in dimethyl sulfoxide (DMSO) to chemically crosslink the mesh dense network of MWCNTs via the π-π bonding.

For the bioanode 170, following the PBSE treatment, the glucose selective enzyme, pyrroloquinoline quinone glucose dehydrogenase (PQQ-GDH) dissolved in phosphate buffer saline (PBS) is covalently attached onto the PBSE modified MWCNTs for specific glucose binding. This protocol is repeated for the biocathode 180 using the oxygen selective enzyme, bilirubin oxidase (BOD).

All surface modifications were done by immersing the bioelectrodes 170 and 180 in the respective reagents. The functionalized bioelectrodes 170 and 180 show high specificity for glucose and oxygen binding. Furthermore, the bioelectrodes 170 and 180 were coated with nafion to selectively screen against interfering analytes.

Each bioelectrode 170 and 180 employed in the glucose biofuel cell 110 preferably has an active surface area of 0.04 cm² and is formed from two mesh network of MWCNT substrate frames, and 200 μm tungsten wire 190 is preferably manually attached by silver conductive epoxy. This enables the glucose biofuel cell 110 to be handled easily and provides for electrical connection to the recording instrument. The region around the uppermost edges of the substrate frames is preferably sealed with polyimide HD-2611 to ensure good insulation.

Characterization of the glucose biofuel cell 110 in the presence of a continuous supply of glucose analyte determines the bioelectricity parameters by analyzing its current-voltage response. The current-voltage response of the glucose biofuel cell 110 shows that successive changes in glucose concentration levels have a direct correlation with the current produced. The current increases immediately with increases in the glucose concentration levels, and it quickly reaches a steady-state. The average response time of the glucose biofuel cell 110 used in testing was as short as 1 second (to reach 95% of steady state short circuit current).

The glucose biofuel cell 110 is preferably designed to achieve direct electron transfer between the active center of the enzyme and the current collector, where the electrons produced from the oxidation of glucose at the bioanode 170 is transferred to the electrode and flows through the external circuitry to recombine at the biocathode 180 for the reduction of molecular oxygen to water, as schematically shown in FIG. 2B. The transfer of electrons yields a measurable current flow through the external circuitry (1.325 mA/cm² in the described glucose biofuel cell 110).

The enzyme loading at the bioanode 170 and biocathode 180 is preferably further tuned to maximize the sensing sensitivity. The optimal enzyme loading for the bioanode 170 and biocathode 180 were 3 mg/ml in the described glucose biofuel cell 110. For increased throughput analyses, glucose biofuel cell 100 was laid down in a holder with a microfluidic chamber placed on top and connected to a peristaltic pump using a syringe. The chamber had a sample volume of 100 μL and enabled triplicate measurements under physiological conditions (e.g., 37° C. and pH 7.4).

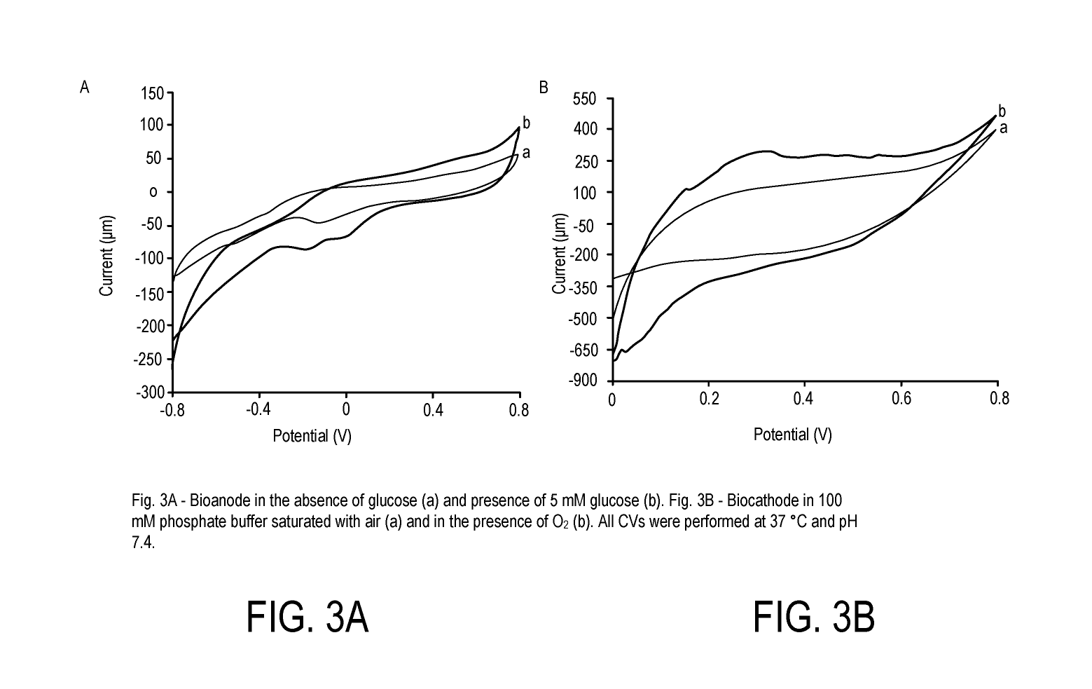

FIGS. 3A and 3B are graphs showing the typical electrocatalytic response of the bioanode 170 in the absence (a) and presence (b) of 5 mM glucose and the typical electrocatalytic response of the biocathode 180 in the absence (a) and presence (b) of oxygen saturated PBS, respectively. The cyclic voltammogram (CV) confirmed the direct electron transfer between the active center of the bioelectrodes and the MWCNTs. The CV experiments were performed at physiologic conditions (37° C., pH 7.4) at a scan rate of 10 mV s⁻¹. The characteristic oxidizing onset voltage for PQQ-GDH in the presence of 5 mM glucose was detected at around −298 mV vs Ag/AgCl (FIG. 3A), whereas the reducing onset voltage for bilirubin in the presence of oxygen was detected at 434 mV vs Ag/AgCl (FIG. 3B).

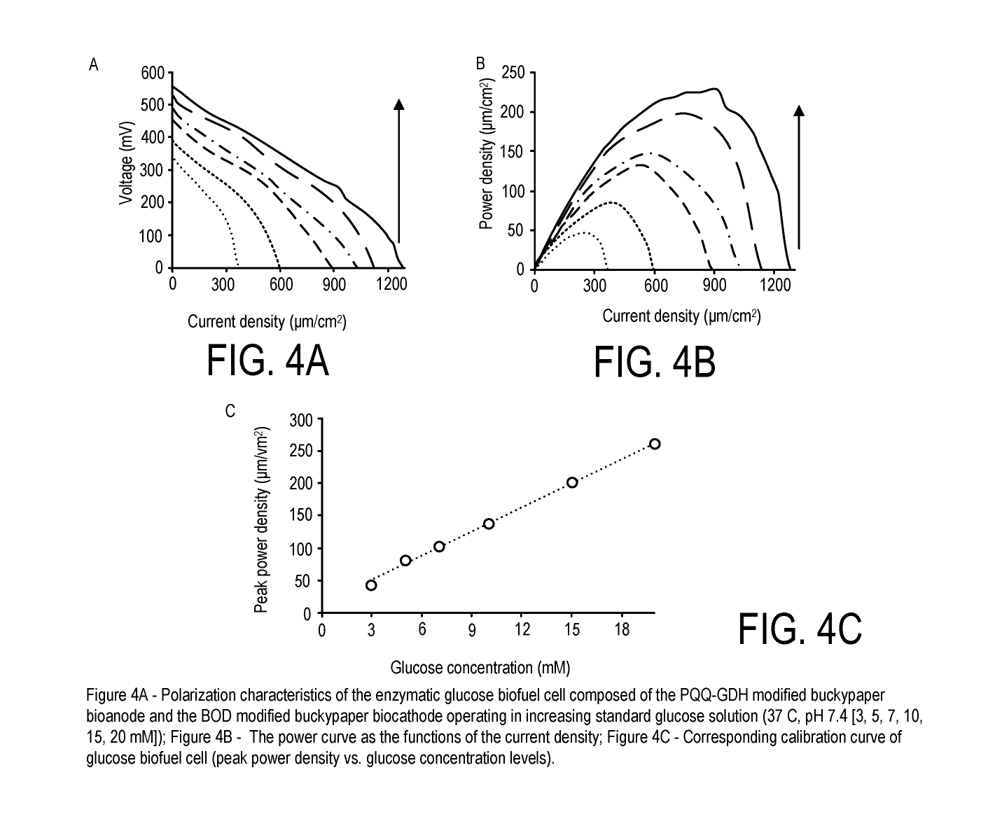

To characterize the glucose biofuel cell 110, various glucose concentrations were supplied continuously to the glucose biofuel cell 110 through the use of a peristatic pump and the current-voltage response was acquired using a variable load resistor. Following the acquisition of the current-voltage response, we calculated the current and power densities were calculated using the geometrical surface area of the active region of the bioelectrode (FIG. 4A). The polarization curves as a function of glucose concentration showed the electrical power density to be linearly related to the amount of glucose that was supplied to the biofuel cell (FIG. 4B).

Therefore, both the open circuit voltage and the short circuit current generated by the glucose biofuel cell 110 was observed to be in correlation with glucose concentration. In 20 mM glucose, the open circuit voltage and short circuit current density, along with a peak power density, were 0.552V, 1.285 mA/cm² and 0.225 mW/cm² at a cell voltage of 0.285 V, respectively. The observed open circuit voltage, short circuit current and power densities under physiological conditions (5 mM, pH 7.4 and 37° C.) were 0.391 V, 0.603 mA/cm² and 84.64 μW/cm² at a cell voltage of 0.214 V, respectively.

The glucose biofuel cell 110 presents excellent linear peak power-concentration relationship at the concentration regime ranging from 3 to 20 mM (FIG. 4C). The linear coefficient was calculated to be 0.997 in this regime. Therefore, the glucose biofuel cell 110 as a standalone power source device can function as a glucose sensor using glucose selective enzymes to oxidize glucose. Rapid amplification of the power generated by the glucose biofuel cell 110 can improve the powering of implantable bioelectronic devices and glucose monitoring, which is accomplished by integrating the glucose biofuel cell 110 with a charge pump IC 120 and a capacitor circuit 130.

### The Charge Pump IC

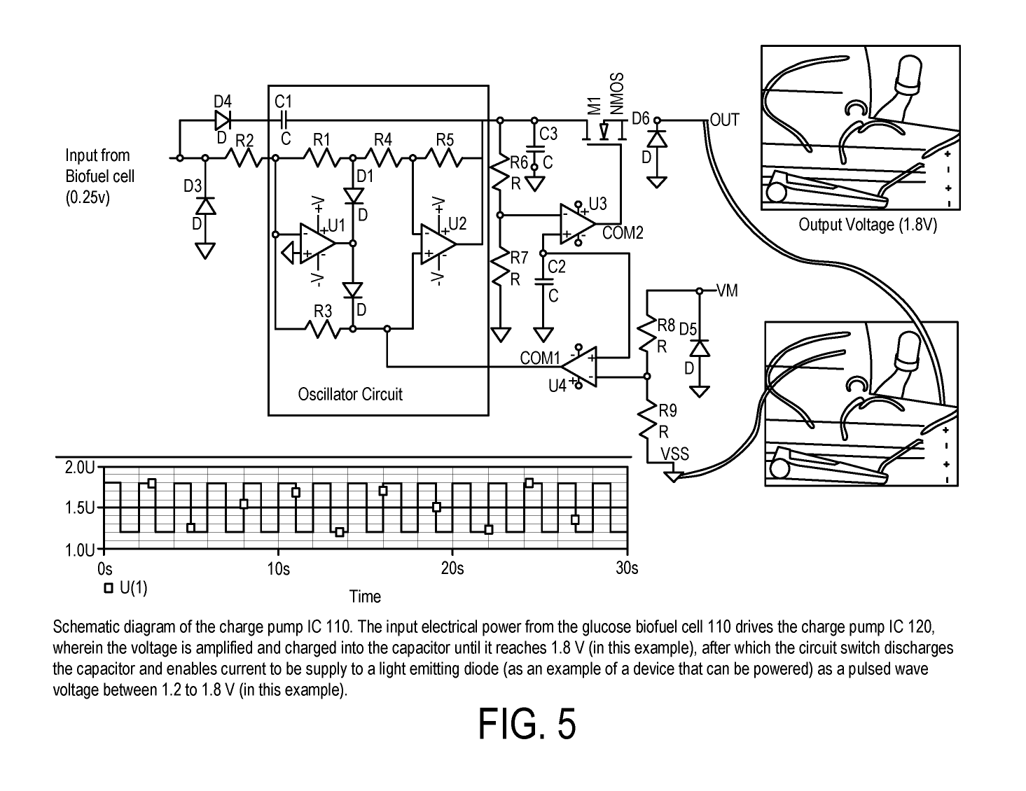

A schematic diagram of one preferred embodiment of the charge pump IC 120 is shown in FIG. 5. The charge pump IC 120 preferably consists of capacitors and switches and can be modified based on applications. The charge pump IC shown in FIG. 5 requires a minimum input supply of 0.25 V from the glucose biofuel cell 110 to trigger its internal oscillation circuit. As such, the clock signal from the oscillation circuit steps up the input voltage from the glucose biofuel cell 110 and gradually charges to start up the capacitor circuit 130 interfaced to the charge pump IC 110. Once the voltage across the capacitor 130 circuit reaches the threshold voltage (1.8 V in this example), the charge pump IC 120 discharges the capacitor 130 to the stop discharge voltage of 1.2 V (in this example) from the OUT pin and the electric power is charged to the capacitor 130 all over again.

The charge pump IC 120 is used to amplify the nominal glucose biofuel cell voltage to a relatively high voltage (1.8 V in this example) along with relatively high current (1.46 mA in this example) using a 0.1 μF capacitor (in this example), which then supplied that stored energy as a burst of power sufficient enough to drive a light emitting diode (LED) without affecting the design of the glucose biofuel cell 110. This demonstrates the ability of a single glucose biofuel cell 110 to power a small electronic device.

The rate at which the electrical power is supplied via the charge pump IC 120 is dependent on the concentration of glucose and the capacitance of the capacitor 130. As the capacitance of capacitor 130 is increased, the frequencies of the charge/discharge cycle decreases. Additionally, the resulting charge/discharge voltage can be observed across the capacitor 130, which in turn serves as a transducer.

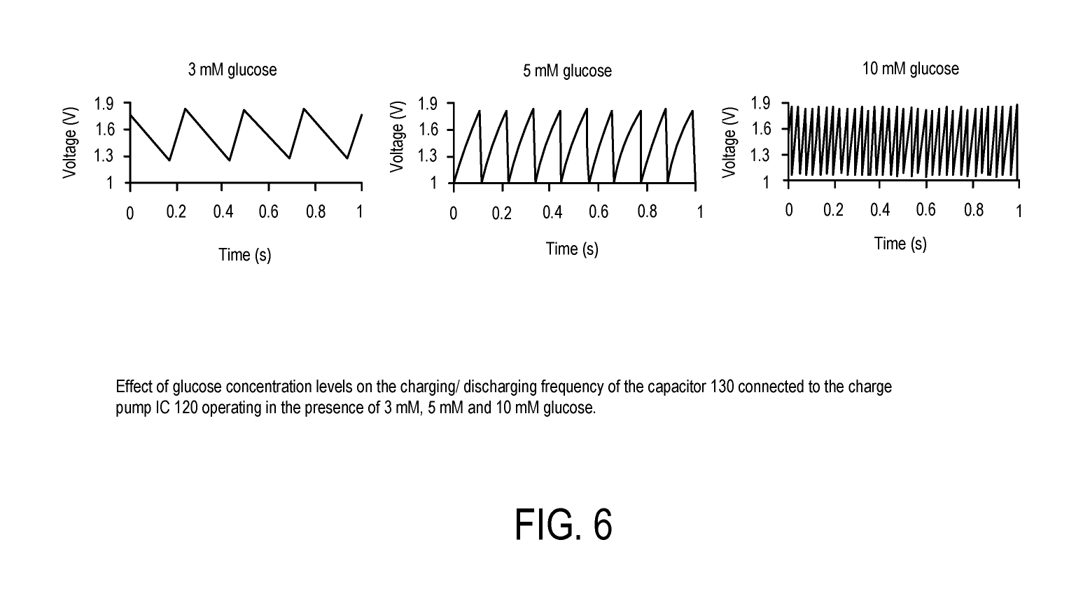

Studies revealed the effect of glucose concentration on the charge/discharge frequency of the capacitor 130 to be dependent on the capacitance of the capacitor 130 and the electrical potential, current and power generated by the glucose biofuel cell 110. This, in turn, is dependent on glucose concentration, since glucose oxidation catalyzed by PQQ-GDH at the bioanode 170 increases in a glucose concentration-dependent manner, thereby enabling the capacitor 130 to function as a transducer, as shown in the graphs of FIG. 6.

The glucose concentration levels were further tuned, thereby maximizing the linear dynamic range (1-45 mM) and detection sensitivity (23.12 Hz/mM·cm²). The charge/discharge frequency of the capacitor 130 correlated well (R²=99.81%) with increasing glucose concentration levels:

Frequency response (Hz)=0.9252 [glucose](mM)+14.113 (Hz) (1)

### pH and Temperature Dependent Studies

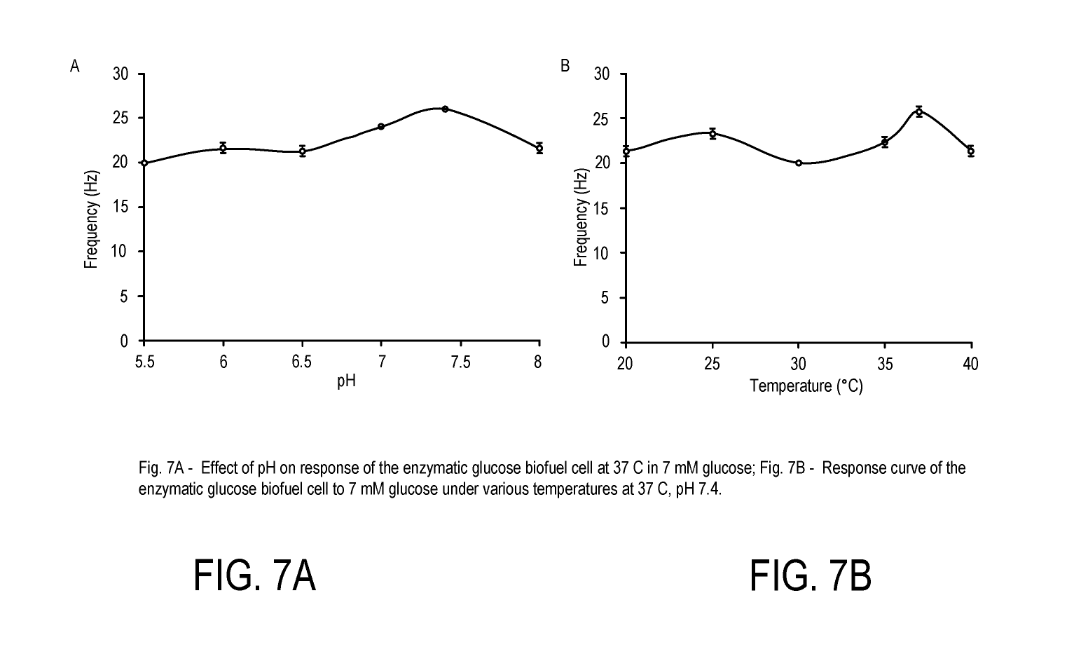

To establish pH and temperature dependent profiles in response to glucose for the glucose-based biofuel power and sensing system of the present invention, the system was exposed to 7 mM glucose over an investigated pH range of 5.5-8.0, the results of which are shown in the graph of FIG. 7A. The observed optimal pH was 7.4, which was significantly higher than that of a system based on laccase as the cathodic enzyme (˜7). Such optimal pH of the glucose-based biofuel power and sensing system of the present invention is attributed to the use of BOD as the cathodic enzyme, thereby enabling the system to operate at physiologic pH as this is essential from an in vivo and/ex vivo perspective.

A temperature range of 20-40° C. was also investigated, the results of which are shown in the graph of FIG. 7B. With respect to the temperature profile, the response intensity of the glucose-based biofuel power and sensing system increased with temperature from 30-37° C. and subsequently decreased at 40° C. We observed two optimal temperatures of 25° C. and 37° C., which indicates that the system is thermally stable at room temperature, as well as at physiological temperature. Additionally, the 37° C. optimal represents about a 3° C. shift when compared to the 40° C. optimum observed for a laccase based system. The observed 37° C. optimum for this system is ideal for in vivo and ex vivo applications.

### Selective Screening Against Interfering Analytes

To determine the system selectivity, the charge/discharge frequency of the capacitor 130 in the glucose-based biofuel power and sensing system of the present invention in the presence of competing and non-competing analytes under physiological concentrations close to an in vivo environment. The physiological glucose concentration in serum is ˜5 mM, whereas the physiological concentration of competing (e.g., fructose, maltose and galactose) and non-competing (e.g., ascorbic acid and uric acid) interfering species is ≤0.42 mM. These interfering species have been shown to have a significant impact on the performance of the glucose sensors in general.

The glucose-based biofuel power and sensing system of the present invention showed no response to 0.2 mM ascorbic acid or 0.5 mM uric acid in the presence of 5 mM glucose. This could be attributed to the low voltage (<0.6 V) generated by the system, which is well below the 0.6 V to 0.7 V vs. Ag|AgCl|KClₛₐₜ necessary for the decomposition of ascorbic and uric acid. Moreover, the bioelectrodes 170/180 were coated with a negatively charged polymer, Nafion, which prohibits the passage of negatively charged interfering species, such as ascorbic and uric acid, to the bioelectrodes 170/180.

The ability of the Nafion membrane to restrict the penetration of non-competing analytes in a complex medium improved the accuracy of the glucose-based biofuel power and sensing system of the present invention. Interestingly, no response was observed for fructose, maltose or galactose in the presence of 5 mM glucose. However, a negligible voltage response to these three competing analytes was observed when introduced individually. This negligible voltage was insufficient to drive the charge pump IC 120, thus no charge/discharge frequency could be observed across the capacitor 130. Accordingly, both competing and non-competing analytes at their physiological concentration have no effect on the performance of the glucose-based biofuel power and sensing system of the present invention. The glucose-based biofuel power and sensing system of the present invention exhibits unprecedented selectivity to quantitatively screen against interfering species.

### Stability of Electrical Power Generation

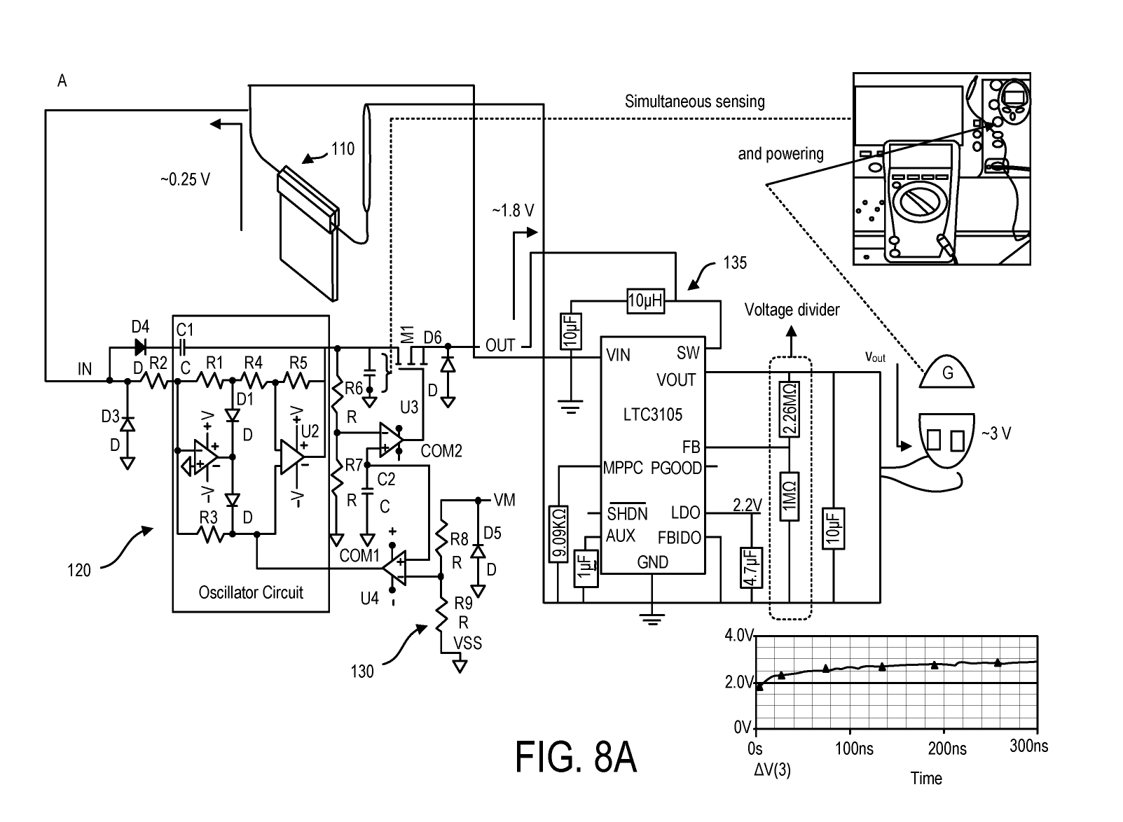

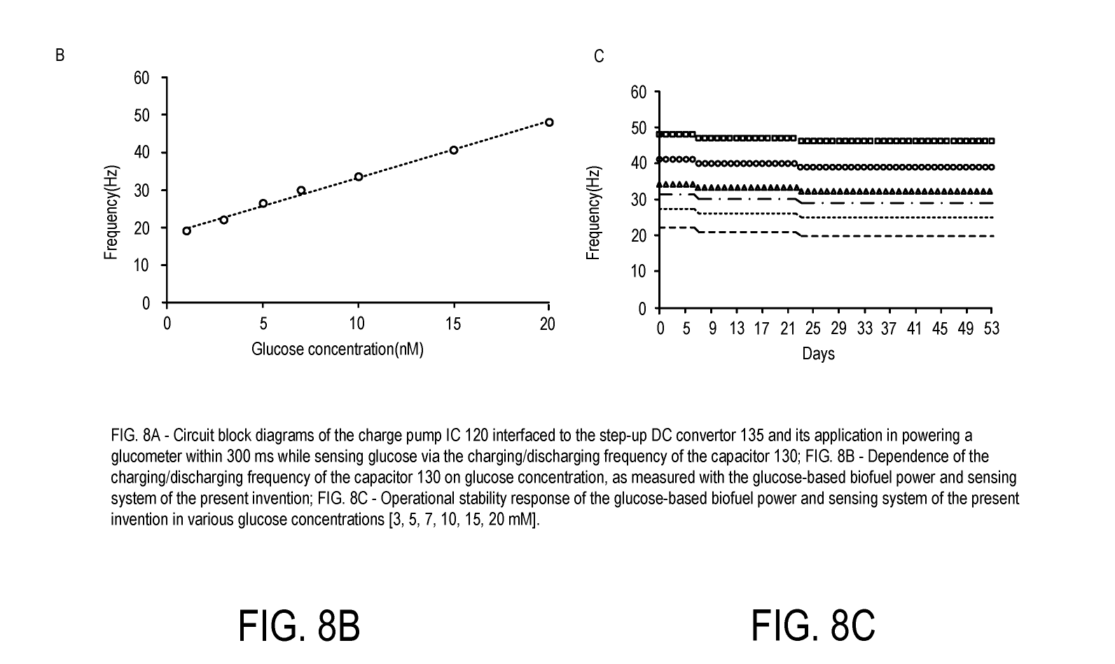

Several technical modifications could be made to improve the glucose-based biofuel power and sensing system of the present invention and accelerate its application for continuous glucose sensing and powering bioelectronics devices (e.g., a glucometer). First, using a step-up DC converter circuit 135, the burst supply of power from the capacitor 130 is converted into a steady DC output supply that is a substantially higher voltage (3.2 V in the described example) for powering small devices. In the described embodiment, the step-up DC converter circuit 135 requires a triggering voltage of 1.4 V to start its operation and maintains its operation with a minimum operating voltage of 0.225 V, all of which is easily fulfilled by the glucose biofuel cell 110/charge pump IC 120/capacitor 130 combination. Also, the step up DC converter circuit 135 is preferably implemented using a voltage divider circuit, as shown in the schematic diagram of FIG. 8A, to tune the DC output voltage by varying the R₁ and R₂ ratio in the following equation:

$${V}_{OUT} = 1.004 * ( ( \frac{{R}_{1}}{{R}_{2}} ) + 1 ) \qquad ( 2 )$$

PSpice simulation studies of the circuit of FIG. 8A revealed that the output voltage increases with the increase in the resistance ratio according to ohm's law. However, the experimental implementation showed that the output voltage varies from those obtained during the simulation. This could be attributed to various voltage losses arising from the circuit design that was not considered in the simulation. The resulting experimental resistance ratio of 1.390 Ω, 1.632Ω, and 2.260Ω yielded steady output voltages of 1.95 V, 2.07 V, and 3.2 V, respectively. The steady 3.2 VDC output voltage achieved with R₁=2.26 MΩ and R₂=1 MΩ was sufficient to power an LED, digital thermometer and glucometer within 300 ms, as illustrated in FIG. 8A.

The glucose-based biofuel power and sensing system of the present invention continuously sensed glucose while simultaneously operating a FeeStyle Lite glucometer, which requires a 3 V input supply. The calibration curve shown in FIG. 8b showed a dynamic range of 1-20 mM glucose with the following regression equation (R²=0.9942):

Frequency response (Hz)=1.5062 [glucose] (mM)+(18.302)(Hz) (3)

which is broad enough for most blood samples in clinical applications. Since glucose sensing was dependent on the power generated by the glucose-based biofuel power and sensing system of the present invention, the charge/discharge frequency was slightly enhanced by the simultaneous operation of the glucometer. This resulted in an increased sensitivity to 37.66 Hz/mM·cm², which is over 2-fold higher than previously reported. These results demonstrated that by monitoring the frequency of the capacitor's charge/discharge voltage, glucose concentration levels can be measured while simultaneously powering a small electronic device via the OUT pin.

To demonstrate that the glucose-based biofuel power and sensing system of the present invention is stable under continuous operation, a concentration-varying experiment in which concentration of glucose was successfully increased from 3 mM to 20 mM concentration was performed under constant load discharge for 1 h each day over a period of 53 days, while monitoring the charge/discharge frequency of the capacitor, the results of which are shown in FIG. 8C. A slight drop of 2.08% to 4.54% in the charge/discharge frequency was observed in the presence of 20 mM to 3 mM glucose after the first week of continuous operation. The overall drop in the frequency was 4.17% to 9.09% in the presence of 20 mM to 3 mM glucose over a period of 53 days of operation.

The glucose-based biofuel power and sensing system of the present invention presented almost the same signals for the same glucose concentrations over the 53 days and retained greater than 91% of its activity at day 53. The glucose-based biofuel power and sensing system of the present invention's stability is greatly enhanced by the capacitor's capacitance, thereby enabling stable continuous monitoring of glucose concentration.

Unlike conventional amperometric glucose sensors that require bulky potentiostat circuits, the glucose-based biofuel power and sensing system of the present invention employs a dense mesh network of MWCNTs, which provides enlarged specific surfaces for enzyme immobilization and facilitate the transport of glucose molecules, hydrogen ions and electrons. This scheme makes it possible to use a compact setup and construct a densely packed sensing unit that exhibits unprecedented sensitivity and linear dynamic range. This nanoscale platform offers a much greater effective surface area than planer materials, which is critical for increasing the density of the immobilized enzyme, and hence the sensitivity of the glucose-based biofuel power and sensing system of the present invention. The fast response of the glucose-based biofuel power and sensing system of the present invention is attributed, at least in part, to the porous MWCNT nanostructures that facilitated the diffusion of the glucose.

The high sensitivity resulted from the immobilization of the enzyme via PBSE on the MWCNTs and the Nafion coating, which selectively screened against interfering analytes, preserved the high activity of the enzyme and its catalytic effects. Additionally, both competing and non-competing analytes at their physiological concentration were shown to have no effect on the performance of the glucose-based biofuel power and sensing system of the present invention. The glucose-based biofuel power and sensing system of the present invention exhibits unprecedented selectivity to quantitatively screen against interfering species.

With increasing glucose concentration, the capacitor 130 displays charge/discharge frequency changes proportional to the target glucose levels. Compared to conventional glucose sensors (glucometers and CGMs), the glucose-based biofuel power and sensing system of the present invention offers highly sensitive and selective glucose analyses and enables continuous and dynamic monitoring of glucose levels in real-time, without the associated infrequent sampling of glucometers and frequent maintenance and replacement of continuous glucose monitors.

In order to improve the power output of the system, a DC-DC converter 135 is integrated to enable the system to supply stable 3.2 V to power an external device, such as a glucometer. Therefore, the integrated system can be readily used to extract glucose concentration information from the glucose biofuel cell for glucose monitoring.

The glucose-based biofuel power and sensing system of the present invention is capable of simultaneously sensing glucose and powering a digital device, such as a glucometer. The system generates electrical power via the direct conversion of biomolecular recognition and binding events to electronic signals that can be monitored electronically. By combining the advantages of porous MWCNTs and energy amplification circuits, the glucose-based biofuel power and sensing system of the present invention exhibits unprecedented performance with high sensitivity, selectivity, and fast response time.

The glucose-based biofuel power and sensing system of the present invention is readily scalable for powering small electronic devices, and can be greatly reduced in footprint by using microsystem techniques and other inexpensive deposition methods to deposit dense mesh network of carbon nanotubes and/metal wire traces.

### A Lactate-Based Biofuel Power and Sensing System

As discussed above, the present invention can be adapted to use a biofuel other than glucose. One such biofuel is lactate, and the biofuel cell can be adapted to accordingly in order to obtain a lactate-based biofuel power and sensing system, in accordance with another embodiment of the present invention.

The lactate-based biofuel power and sensing system is similar to the glucose-based biofuel power and sensing system described above, however a lactate biofuel cell is used in place of the glucose biofuel cell.

Lactic acid concentration levels can serve as excellent biomarkers for monitoring tissue and organ health. Generally, lactic acid exists as L-(+) and D-(−) enantiomers. While L-(+)-lactate is the normal intermediate in mammalian metabolism, the D-(−) enantiomer is usually produced by microorganisms, algae, and plants and is of limited utilization in humans. Determination of L-lactate concentration in blood is essential for the diagnosis of patient conditions in intensive care and during surgery.

An elevated lactate level in blood is a major indicator of ischemic conditions of the respective tissue. This ischemic situation can be caused by shock trauma, respiratory insufficiency, carbon monoxide or cyanide intoxication, etc. Another cause for an altered lactate level is a disturbed lactate metabolism, which may sometimes be attributed to diabetes or absorptive abnormalities of short-chain fatty acids in the colon. In sport or space medicine, blood lactate levels during exercise can be used as an indicator of training status and are now common for monitoring training and fitness of athletes or racing animals.

Thus, it is apparent that lactate is an important metabolite and monitoring the existence or production of L- and D-lactic acid in a variety of media is of great interest. Among the various conventional analytical methods available for the determination of this analyte, colorimetric tests and chromatographic analysis are commonly used. However, these methods are complex, laborious and time consuming, and complicated by intensive sample pre-treatment and reagent preparation. An embodiment of the present invention that utilizes a lactate biofuel cell is alternative method for lactic acid detection that is simple, direct, inexpensive and enables real-time sensing with no need for sample preparation.

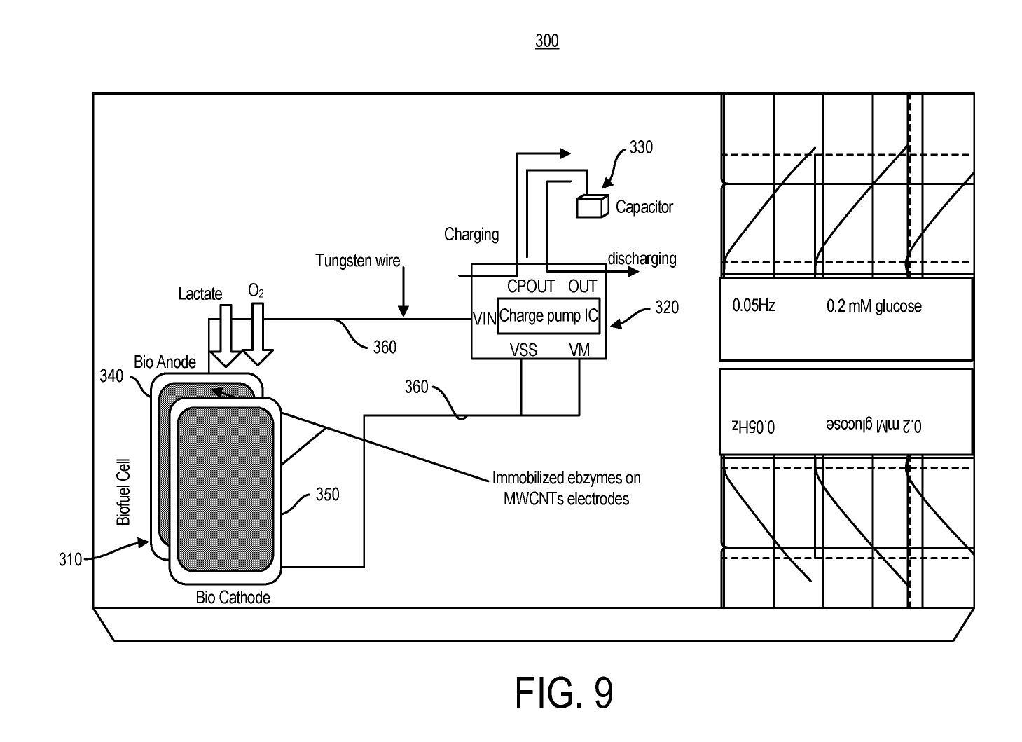

FIG. 9 is a schematic diagram of a lactate-based biofuel power and sensing system 300, in accordance with one embodiment of the present invention. The lactate-based biofuel power and sensing system 300 is based on the integration of a lactate biofuel cell 310 with a charge pump IC 320 and a capacitor 330. The electric power generated by the lactate biofuel cell 310 results from the oxidation of lactate and the reduction of oxygen. This electric power is subsequently charged into the capacitor 330 via the charge pump IC 320 until the capacitor 330 reaches the discharge start voltage. Then, the charge pump IC 320 will discharge capacitor 330 from the OUT pin until the potential is reduced to the discharge stop voltage, and then the capacitor 330 will be charged again. The charging/discharging frequency of the capacitor 330 correlates to lactic acid concentration.

Buckypaper square sheets (suitably 3 mm×2 mm) were utilized as electrode materials for the construction of the lactate biofuel cell 310. The electrodes were washed with 2-proponal to remove impurities from the surface and subsequently modified with pyrenebutanoic acid succinimidyl ester (PBSE) cross-linker to establish noncovalent π-π stacking between the aromatic rings of PBSE and MWCNTs. D-LDH (0.8 mg/ml) was prepared in 10 mM phosphate buffered saline (1 mM CaCl₂, pH 7) and immobilized onto the PBSE modified electrode in the dark at room temperature. This electrode served as the bioanode 340, whereas the biocathode 350 was functionalized with 1 mg/ml bilirubin oxidase (BOD)/10 mM PBS (pH 7).

Immediately following enzyme immobilization, the bioelectrodes 340 and 350 were coated with Nafion. The bioanode 340 and biocathode 350 were fixed in place via polyimide and a pair of 200 μm tungsten wires 360 were used as the electrical leads to connect the lactate biofuel cell 310 to the charge pump IC 320 to construct a complete lactate-based biofuel power and sensing system. The bioelectrodes 340 and 350 are preferably spaced 1 cm apart and the lactic acid substrate was introduced via capillary action.

A substrate material, such as the dense mesh network of multi-walled carbon nanotubes with high surface area, is crucial to enhancing the enzyme loading and hence the electrocatlaytic activity to generate large electrical power from the constructed lactate biofuel cell 310. The respective enzymes were successfully immobilized on to the PBSE modified electrodes via the formation of amide bonds between the amino groups on the protein and the carboxyl group provided by PBSE [13], wherein the double bond between the carbon and oxygen on PBSE is broken, leaving oxygen with a negative formal charge as the electrons move towards the more electronegative species.

An unstable intermediate is formed when the nitrogen from the enzyme's amino group donates electrons to the now electron-deficient carbon on the PBSE and subsequently develops a positive formal charge. The π electrons on the oxygen reform the double bond with the carbon atom on the PBSE. Simultaneously, the ester group also attached to the carbon breaks off, along with one of the hydrogen attached to the nitrogen, thus leaving behind a neutral, immobilized enzyme. D-lactate dehydrogenase (D-LDH) was used to catalyze the oxidation of lactic acid and bilirubin oxidase was used to catalyze the reduction of molecular oxygen as illustrated in the redox equations of the two half reactions below:

Anode: Lactate→Pyruvate+2H⁺+2e⁻ (4)

Cathode: (½)O₂+2H⁺+2e⁻→H₂O (5)

Under stressful conditions, such as shock trauma in biological species, the production of lactic acid increases, hence lactate dehydrogenase was selected to oxidize lactate since it does not produce toxic hydrogen peroxide byproduct which can subsequently foul the electrode surface. Lactate oxidase was not employed in the bioelectrode design because it was observed to be difficult to achieve direct electron transfer on carbon nanotube surfaces without the use of mediators.

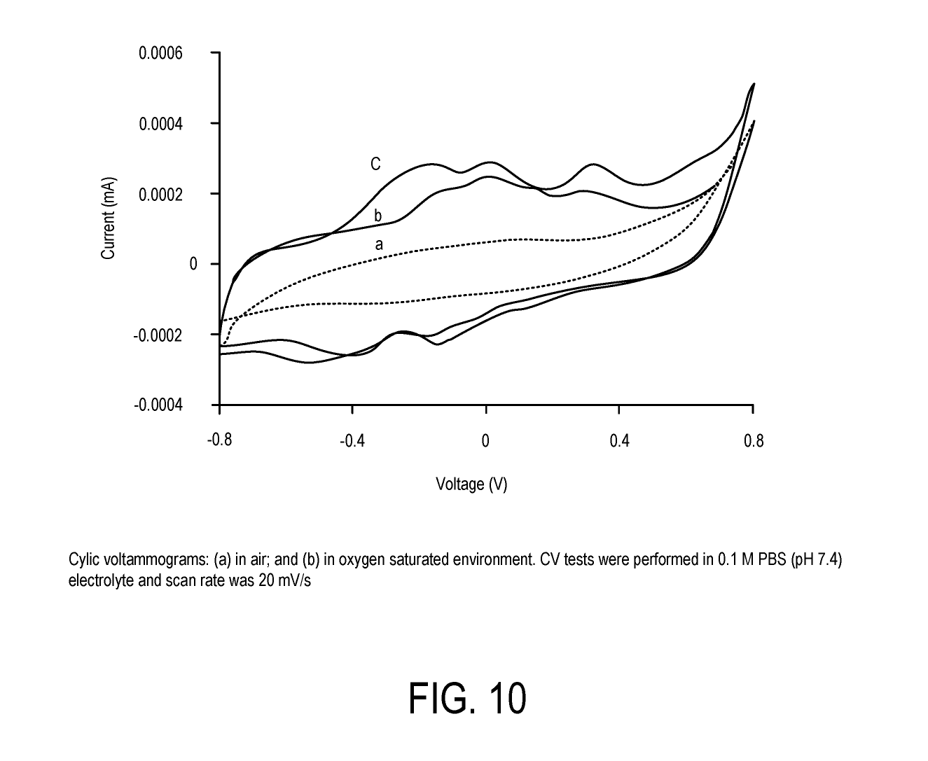

To evaluate the electrocatalytic activity of the bioanode 340 and biocathode 350, cyclic voltammetry (CV) curves of the corresponding bioelectrodes were measured under their respective analytes. According to the measurements acquired with the D-LDH functionalized bioanode 340, as shown in FIG. 10, the intensity in the reaction peak increased in the presence of increasing lactate concentrations, 7 mM (shown with curve b) and 15 mM (shown with curve c) at an oxidation onset potential of between −0.28 V−0.46 V vs. Ag/AgCl which is comparable to those previously reported. It is evident that the CV profile in the presence of lactic acid remained relatively unchanged irrespective of the lactic acid concentration level thereby indicating that the D-LDH catalyst reacts with lactic acid and in turn is the best catalyst for lactic acid oxidation reaction.

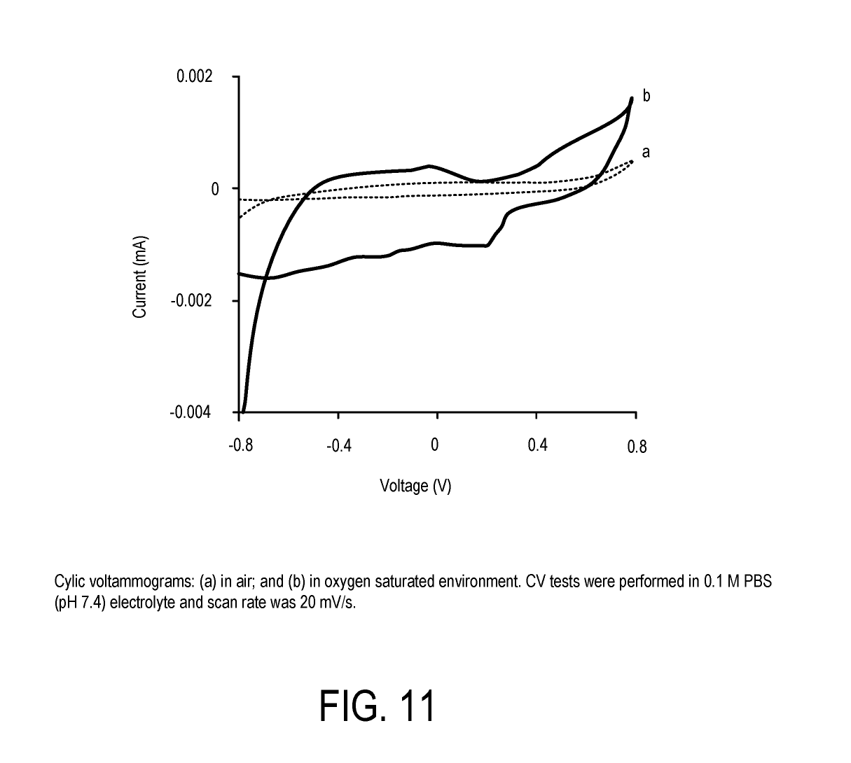

To examine the electrochemical reaction at the biocathode 350, the effect of dissolved molecular oxygen gas on the electrocatalytic activity of the functionalized BOD biocathode was examined. FIG. 11 represents the CV curves of the biocathode 350 in the presence and absence of dissolved molecular oxygen. Insignificant electrocatalytic activity was observed in the absence of oxygen, whereas the onset of oxygen reduction was observed at ca. +0.32 V vs. Ag/AgCl in the presence of dissolved oxygen. The down-shift in the electrocatalytic current is attributed to oxygen reduction reaction.

These effects are ascribed to the increased active surface area achieve with the carbon nanotubes for enzyme immobilization and the formation of amide bonds between the enzymes and PBSE and the formation of 7C-7C stacking on CNTs. All these effects enabled the electron transfer between the active center of the enzyme to the carbon nanotubes, thereby implying that both D-LDH and BOD were successfully immobilized on the dense mesh network of carbon nanotubes.

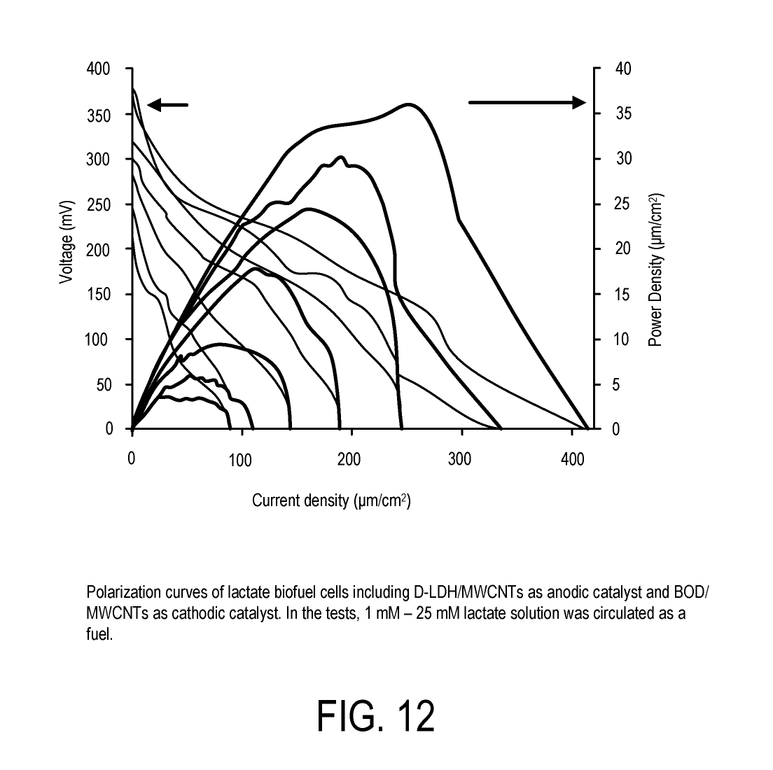

The electrical power generated by the lactate biofuel cell 310 was determined using a series of resistance loads ranging from 1 MΩ to 0Ω, while monitoring both potential and current as a function of time. The obtained data was subsequently employed to generate current-voltage and power-current density curves, as shown in FIG. 12. The open circuit voltages for 25 mM and 15 mM lactic acid solutions were 395.3 mV and 368.4 mV, respectively. The corresponding short-circuit current densities were observed to be 418.8 μA/cm² and 334.25 μA/cm², respectively.

FIG. 12 shows the achievable power of 35.7 μW/cm² at a cell voltage of 0.14 V for 25 mM lactic acid. The lactate biofuel cell 310 is preferably designed for generating electrical power from low lactate concentrations of up to 25 mM for biological samples such as tears, urine and serum.

A stability profile of the lactate biofuel cell was generated over a two-week period. A resistance of 200 kΩ was used as a load. Over the 15-day period, the lactate biofuel cell's electrical power gradually decreased from 32.3 μW/cm² to 14.02 μW/cm² when operating continuously in 25 mM lactate for one week. This represents a 56.5% drop in the original biofuel cell activity and drops by an overall 76.9% by the end of the two-week period.

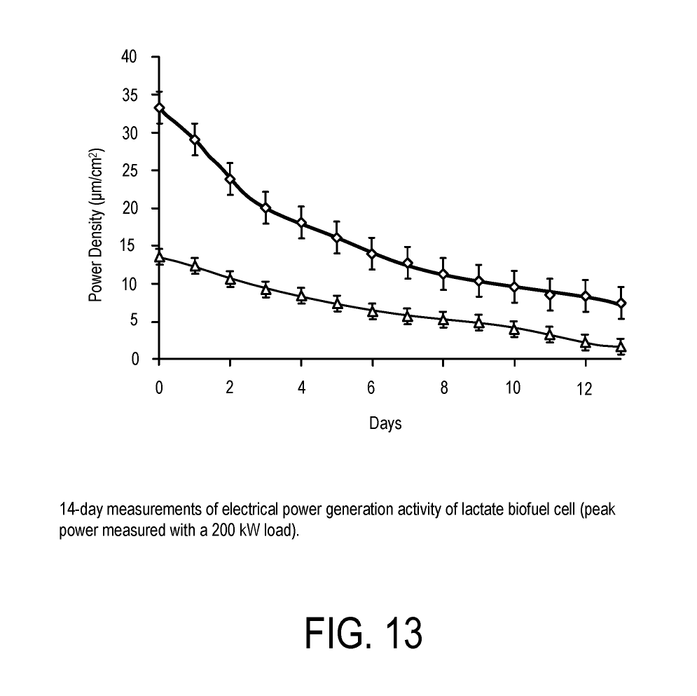

On the other hand, when operating in 1 mM a 52.2% drop in original electrical power was observed at week one and an overall 86.8% was observed at the end of the two-week period, as shown in FIG. 13. According to the stability profile, the system and the bioelectrodes 340 and 350 would need to be calibrated and replaced every two weeks.

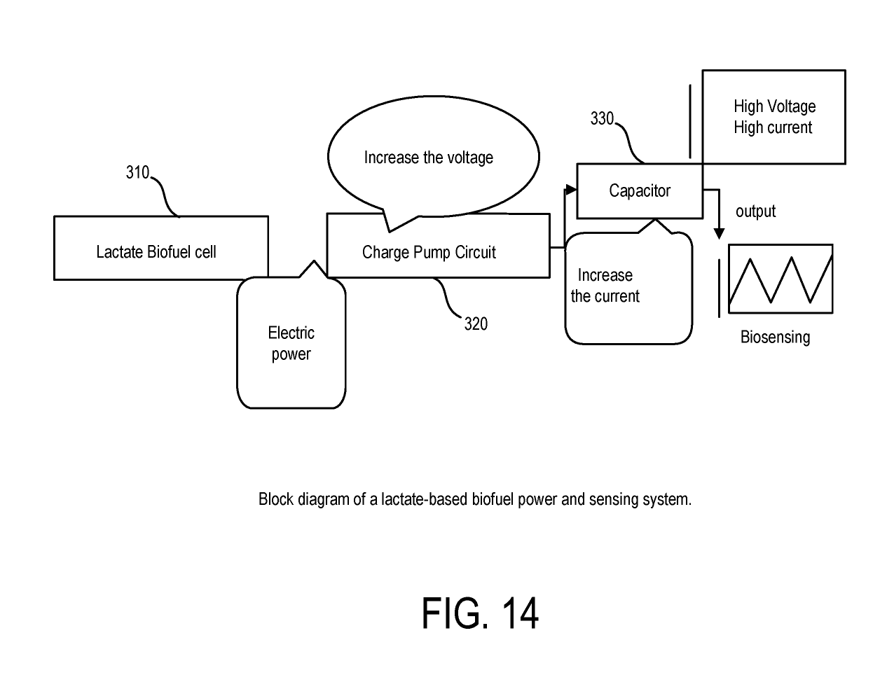

The electrical power generated from the lactate biofuel cell 310 is supplied as the input voltage for the charge pump IC 320, which in the described embodiment requires a minimum operating input voltage of approximately 275 mV. This nominal input voltage from the lactate biofuel cell 310 is then amplified by the charge pump circuit to 1.8 V via the 10 pF capacitor 330 functioning as the lactate transducer. The sensing ability of the system 300 was determined by measuring the charging/discharging frequency of the 10 pF capacitor 330 connected to the charge pump IC 320 in response to lactate concentrations. Once the capacitor 330 is fully charged, the charge pump IC 320 discharges the capacitor 330 until the potential reaches 1.2 V, thereby supplying a burst of power, as shown in the block diagram of FIG. 14.

This charging/discharging of the capacitor 330 continues and is observed to be directly proportional to the biocatalytic oxidation of lactate at the bioanode 340. Thus, by monitoring the capacitor charging/discharging frequency, the exact concentration of the analyte can be deduced. This self-powering system 300 is less costly in terms of the circuit components used when compared to amperometric biosensors. It employs a charge pump IC 320 and a capacitor 330, whereas an amperometric biosensor composed primary of operational precision amplifiers, transistors, resistors, and capacitors.

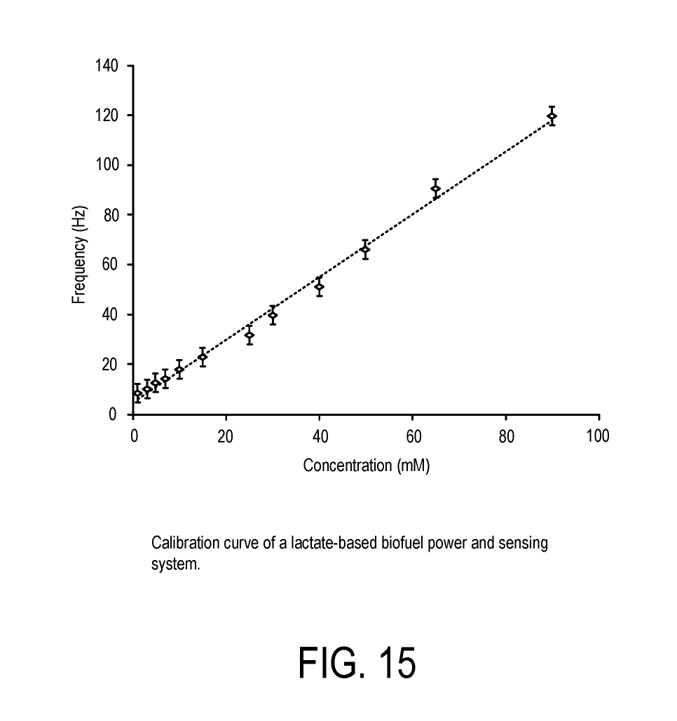

The performance of the lactate-based biofuel power and sensing system 300 in lactic acid solution is shown in FIG. 15. The average frequency of charge/discharge cycle of the capacitor 330 was observed for various levels of lactate analyte. Based on the results obtained, the sensitivity was calculated to be 125.88 Hz/mM-cm² and a linear dynamic range of 1 mM to 100 mM lactic acid was observed with a linear correlation-regression coefficient of 0.9948. These results are higher in comparison to amperometric lactic acid biosensors. The linear calibration curve was determined using the following equation:

Response (Hz)=1.2388 [lactate] (nM)+4.7289 (Hz) (6)

In addition, the lactate-based biofuel power and sensing system 300 of the present invention demonstrates that lactic acid concentration levels above 25 mM, which is common in undiluted biological fluid such as sweat, can be easily sensed. Therefore, the lactate-based biofuel power and sensing system 300 of the present invention is preferably calibrated to sense a wide range of lactate concentration from 1 mM to 100 mM to account for both diluted and undiluted samples, thereby confirming the utility of the system 300 for sensing a wide range of lactic acid concentrations. This includes lactic acid concentrations that are at the normal lactate level in the human body, as well as the maximum level that can occur.

Interfering analytes, such as uric acid, has been shown to exhibit no impact on the sensing of the analyte of interest using the lactate-based biofuel power and sensing system 300 of the present invention. In amperometric biosensors based on oxidase enzymes, the interfering analytes are decomposed at the same potential of ca. +700 mV as the byproduct hydrogen peroxide. In contrast, with the lactate-based biofuel power and sensing system 300 of the present invention, the voltages generated by the lactate dehydrogenase based biofuel cell 310 are below +600 mV, thereby enabling lactic acid to be sensed a with a high degree of selectivity.

The foregoing embodiments and advantages are merely exemplary, and are not to be construed as limiting the present invention. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims.

What is claimed is:

1. An analyte-based power system, comprising:
a biofuel cell, wherein the biofuel cell is adapted to generate an electric signal in the presence of a predetermined analyte;
a voltage amplifier in electrical communication with the biofuel cell that is adapted to receive the electric signal, amplify the voltage of the electric signal, and output a voltage-amplified electric signal; and
a capacitor in electrical communication with the voltage amplifier such that the voltage amplified electric signal charges the capacitor;
wherein the voltage amplifier is adapted to: (1) charge the capacitor with the voltage amplified signal; (2) discharge the capacitor when the capacitor voltage reaches a predetermined level (“discharge voltage”); and (3) re-charge the capacitor with the voltage amplified signal after the capacitor has discharged.

2. The system of claim 1, wherein a frequency at which the capacitor is charged and discharged by the voltage amplifier is correlated to a concentration of the predetermined analyte at the biofuel cell.

3. The system of claim 1, wherein the predetermined analyte comprises glucose.

4. The system of claim 1, wherein the predetermined analyte comprises lactate.

5. The system of claim 1, wherein the voltage amplifier comprises a charge pump integrated circuit.

6. The system of claim 1, wherein an anode and a cathode of the biofuel cell are formed from multi-walled carbon nanotubes.

7. The system of claim 1, wherein the analyte-based power system is adapted to be implanted in a living organism.

8. The system of claim 1, further comprising a device in electrical communication with the capacitor such that the device receives electrical signals discharged from the capacitor (“discharge signals”), wherein the device is adapted to be powered by the discharge signals.

9. The system of claim 8, wherein the device comprises an implantable medical device.

10. The system of claim 8, wherein the device comprises a wearable device.

11. The system of claim 1, further comprising an amplification circuit in electrical communication with the capacitor such that the amplification circuit receives electrical signals discharged from the capacitor (“discharge signals”), wherein the amplification circuit amplifies the discharge signals and outputs amplified discharge signals.

12. The system of claim 11, further comprising a device in electrical communication with the amplification circuit such that the device receives the amplified discharge signals, wherein the device is adapted to be powered by the amplified discharge signals.

13. The system of claim 12, wherein the device comprises a medical device.

14. The system of claim 12, wherein the device comprises a wearable device.

15. A system, comprising:
a biofuel cell, wherein the biofuel cell is adapted to generate an electric signal in the presence of a predetermined analyte;
a voltage amplifier in electrical communication with the biofuel cell that is adapted to receive the electric signal, amplify the voltage of the electric signal, and output a voltage-amplified electric signal;
a capacitor in electrical communication with the voltage amplifier such that the voltage amplified electric signal charges the capacitor, wherein the voltage amplifier is adapted to: (1) charge the capacitor with the voltage amplified signal; (2) discharge the capacitor when the capacitor voltage reaches a predetermined level (“discharge voltage”); and (3) re-charge the capacitor with the voltage amplified signal after the capacitor has discharged;
an amplification circuit in electrical communication with the capacitor such that the amplification circuit receives electrical signals discharged from the capacitor (“discharge signals”), wherein the amplification circuit amplifies the discharge signals and outputs amplified discharge signals; and
a device in electrical communication with the amplification circuit such that the device receives the amplified discharge signals, wherein the device is adapted to be powered by the amplified discharge signals.

16. The system of claim 15, wherein the device comprises an implantable medical device.

17. The system of claim 15, wherein the device comprises a wearable device.

18. The system of claim 1, further comprising an amplification circuit in electrical communication with the capacitor such that the amplification circuit receives electrical signals discharged from the capacitor (“discharge signals”), wherein the amplification circuit amplifies the discharge signals and outputs amplified discharge signals.

19. The system of claim 15, wherein the predetermined analyte comprises glucose.

20. The system of claim 1, wherein the predetermined analyte comprises lactate.
